(19) United States
(12) Patent Application Publication
(10) Pub. No.: US 2013/0117444 A1
(43) Pub. Date: May 9, 2013

(54) LOAD-BALANCING DYNAMIC WEB SERVICES SYSTEM AND METHOD

(71) Applicant: Winshuttle, LLC, Bothell, WA (US)

(72) Inventors: Amit SHARMA, Chandigarh (IN); Mandeepak SINGH, Chandigarh (IN)

(73) Assignee: WINSHUTTLE, LLC, Bothell, WA (US)

(21) Appl. No.: 13/725,680

(22) Filed: Dec. 21, 2012

Related U.S. Application Data
(63) Continuation-in-part of application No. 13/016,704, filed on Jan. 28, 2011.
(60) Provisional application No. 61/334,099, filed on May 12, 2010.

(51) Int. Cl. H04L 29/08

(52) U.S. Cl. CPC H04L 67/16
USPC 709/224

(57) ABSTRACT

A Dynamic Web Service server may facilitate custom Enterprise Application interface development with little or no developer input by dynamically creating a web service for performing a particular transaction according to a transaction map. An Enterprise Application client device may create a transaction map by “recording” a transaction between an Enterprise Application client and an Enterprise Application server and mapping transaction fields to a custom interface generated to collect data for re-performing the recorded transaction. The Enterprise Application client device may call the dynamic web service, and the Dynamic Web Service server may then select a worker to perform the recorded transaction using input data collected in the custom interface.

### CROSS-REFERENCE TO RELATED APPLICATIONS

This application is a continuation-in-part of U.S. Non-provisional application Ser. No. 13/016,704, filed Jan. 28, 2011 under Attorney Docket No. WINS-2010017, titled “DYNAMIC WEB SERVICES SYSTEM AND METHOD,” and naming inventors Vishal Chalana, Amit Sharma, Piyush Nagar, Vishal Sharma, and Vikram Chalana. Application Ser. No. 13/016,704 claims the benefit of priority to U.S. Provisional Application No. 61/334,099, filed May 12, 2010 under Attorney Docket No. WINS-2010016, titled “DYNAMIC WEB SERVICES SYSTEM AND METHOD,” and naming inventors Vishal Chalana, Amit Sharma, Piyush Nagar, Vishal Sharma, and Vikram Chalana. The above-cited applications are incorporated herein by reference in their entireties, for all purposes.

### FIELD

The present disclosure relates to databases, and more particularly to methods of defining and providing dynamic web services for automating database transactions.

### BACKGROUND

Enterprise resource planning (“ERP”) systems are designed to coordinate some or all of the resources, information, and activities needed to complete business processes. An ERP system may support business functions including some or all of manufacturing, supply chain management, financials, projects, human resources, customer relationship management, and the like.

Many ERP systems provide a native application programming interface (“API”) that developers may use to read, write, update, and/or remove data objects on the database level. Some ERP systems may also provide a native API that developers may use for observing, automating, and/or emulating user interactions with the ERP system, such as through a graphical user interface (“GUI”). For example, ERP Servers provided by SAP AG of Weinheim, Germany, typically expose a native API via remote function calls (“RFC”). An RFC is a procedure for data interchange (typically via a TCP/IP connection) between a client (typically an SAP client) and a server (typically an SAP server).

In addition, some ERP systems may expose some or all of a native API as a general-purpose, static “web service,” which can be accessed over a network, such as the Internet, and executed on a remote system hosting the requested services. When using such a web service, clients and servers commonly communicate over the Hypertext Transfer Protocol (“HTTP”) protocol.

There are several web service variants. In one variant, which has been popular with traditional enterprise, clients and servers communicate via Extensible Markup Language (“XML”) messages that follow the Simple Object Access Protocol (“SOAP”) standard. In such systems, there is often a machine-readable description of the operations offered by the service written in the Web Services Description Language (“WSDL”).

Another web service variant conforms to Representational State Transfer (“REST”) constraints and uses HTTP methods such as PUT, GET, DELETE, and POST instead of SOAP messages. RESTful web services may or may not use WSDL definitions and/or XML or JavaScript Object Notation (“JSON”) messages.

Using native APIs such as those described above, it is often possible for developers to create custom forms and/or program custom clients to enable users to perform specific transactions with the ERP system. However, it can be difficult and/or expensive to have developers implement custom interfaces for interacting with an ERP system via a native-API, even an API that is exposed via a web service. Consequently, many businesses must maintain an expensive information technology department and/or use expensive outside consultants to facilitate custom ERP interface development.

### BRIEF DESCRIPTION OF THE DRAWINGS

FIG. 1 illustrates an exemplary ERP system in which a client device, one or more dynamic-web-service manager server, one or more ERP server, and one or more dynamic-web-service worker devices are connected to a network.

FIG. 2 illustrates several components of an exemplary dynamic-web-service manager server.

FIG. 3 illustrates several components of an exemplary client device.

FIG. 4 illustrates several components of an exemplary dynamic-web-service worker device.

FIG. 5 illustrates an exemplary series of communications between client device, dynamic-web-service manager server, and ERP server, in accordance with one embodiment.

FIG. 6 illustrates an exemplary series of communications between client device, dynamic-web-service manager server, dynamic-web-service worker device, and ERP server, in accordance with one embodiment.

FIG. 7 illustrates an exemplary transaction in an ERP client process in accordance with one embodiment.

FIG. 8 illustrates an exemplary transaction recorded in a dynamic web service client, in accordance with one embodiment.

FIG. 9 illustrates an exemplary transaction published from a dynamic web service client, in accordance with one embodiment.

FIG. 10 illustrates a portion of an automatically-generated description of a dynamic web service corresponding to an exemplary transaction, in accordance with one embodiment.

FIG. 11 illustrates a forms authoring tool automatically generating a form according to an exemplary dynamic web service description, in accordance with one embodiment.

FIG. 12 illustrates a form presentation tool obtaining data, in accordance with one embodiment.

FIG. 13 illustrates a routine for recording, mapping, and publishing a dynamic web service, such as may be performed by a client device in accordance with one embodiment.

FIG. 14 illustrates a routine for publishing a dynamic web service, such as may be performed by a dynamic-web-service manager server in accordance with one embodiment.

FIG. 15 illustrates a routine for consuming a dynamic web service, such as may be performed by a client device in accordance with one embodiment.

FIG. 16 illustrates a routine for providing a dynamic web service, such as may be performed by a dynamic-web-service manager server in accordance with one embodiment.

FIG. 17 illustrates a routine for performing a dynamic web service job, such as may be performed by a dynamic-web-service worker device in accordance with one embodiment.

FIG. 18 illustrates a routine for monitoring a dynamic-web-service job status, such as may be performed by a dynamic-web-service manager server in accordance with one embodiment.

### DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

According to various embodiments, as described below, a Dynamic Web Service (“dynamic web service”) server may facilitate custom Enterprise interface development with little or no developer input by dynamically creating a web service for performing a particular transaction, according to a transaction map created by “recording” a transaction between an ERP client and an ERP server.

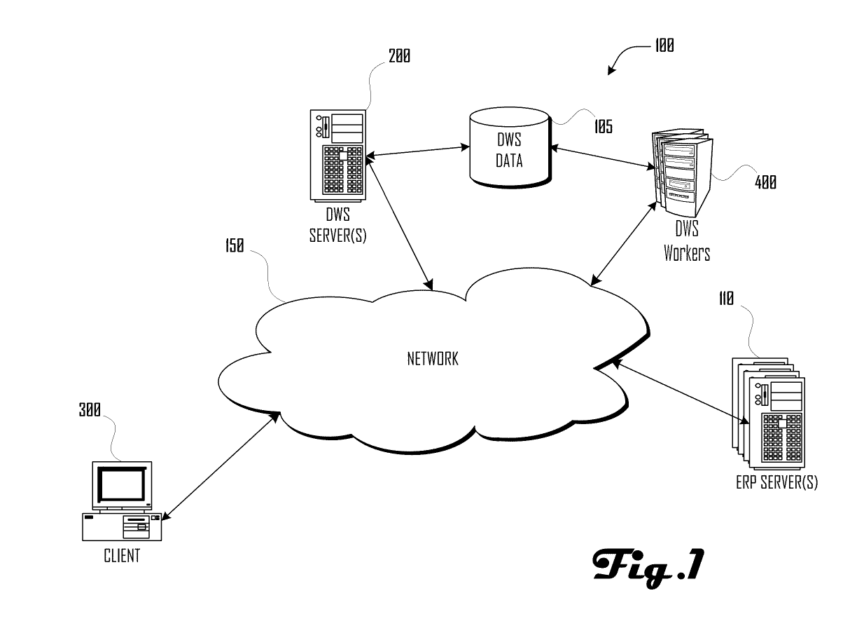

FIG. 1 illustrates an exemplary ERP system 100 in which a client device 300, one or more dynamic-web-service manager server(s) 200, one or more ERP server(s) 110, and one or more dynamic-web-service worker devices 400 are connected to a network 150.

In some embodiments, ERP server 110 may further comprise an application server (not shown), and/or ERP server 110 may further include the functionality of an application server.

Dynamic-web-service manager server 200 is also connected to a dynamic-web-service data store 105. In some embodiments, dynamic-web-service manager server 200 may communicate with dynamic-web-service data store 105 via network 150, a storage area network (“SAN”), a high speed serial bus, and/or via other suitable communication technology.

In various embodiments, network 150 may include the Internet, a local area network (“LAN”), a wide area network (“WAN”), and/or other data network. In other embodiments, dynamic-web-service manager server 200 and/or dynamic-web-service worker devices 400 may communicate with ERP server 110 via a channel other than network 150. For example, ERP server 110 and one or both of dynamic-web-service manager server 200 and dynamic-web-service worker device 400 may be connected via a SAN, a high speed serial bus, and/or via other suitable communication technology. In many embodiments, there may be multiple client devices 300.

In some embodiments, dynamic-web-service manager server 200 and/or dynamic-web-service worker devices 400 may communicate with ERP server 110 and one another via a private network, a virtual private network, a secure network, and/or a secure portion of network 150. For example, in one embodiment, dynamic-web-service manager server 200 and one or more dynamic-web-service worker devices 400 may exist “in the cloud” (e.g. accessible via the Internet or other public network) and dynamic-web-service worker devices 400 may communicate with ERP server 110 via a virtual private network. In another embodiment, dynamic-web-service manager server 200 may exist “in the cloud”, while one or more dynamic-web-service worker devices 400 and ERP server 110 are behind a firewall or otherwise on a private network. In such an embodiment, the dynamic-web-service worker devices 400 may each expose a port or other communication interface(s) such that the cloud-based dynamic-web-service manager server 200 may communicate with dynamic-web-service worker devices 400 without requiring a virtual private network.

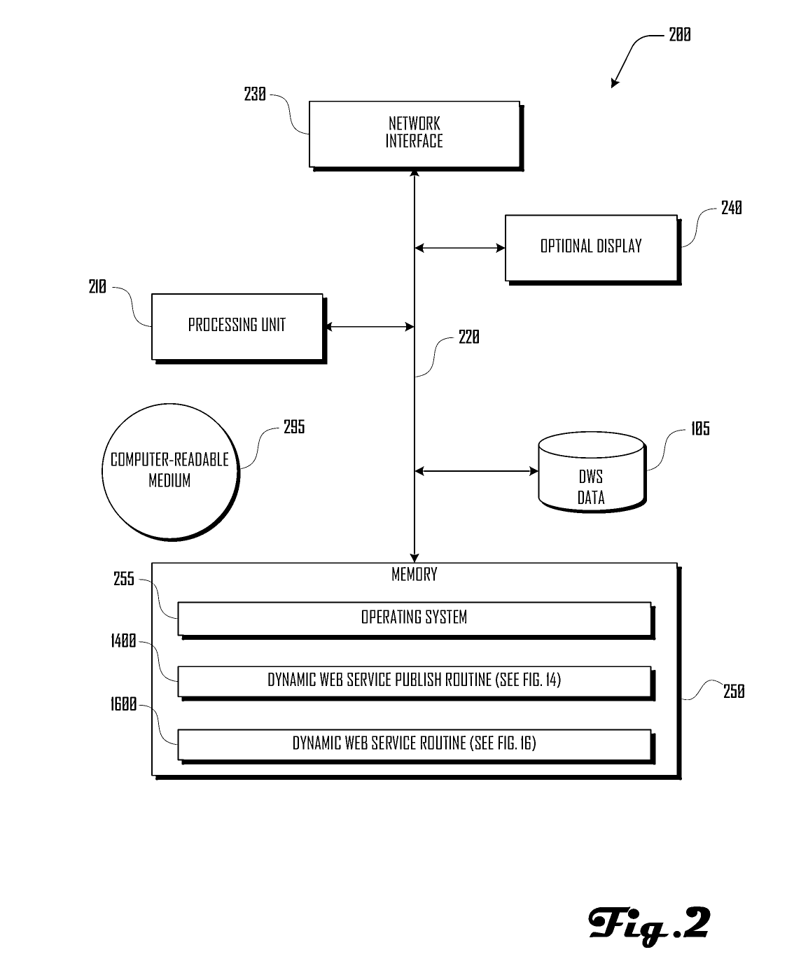

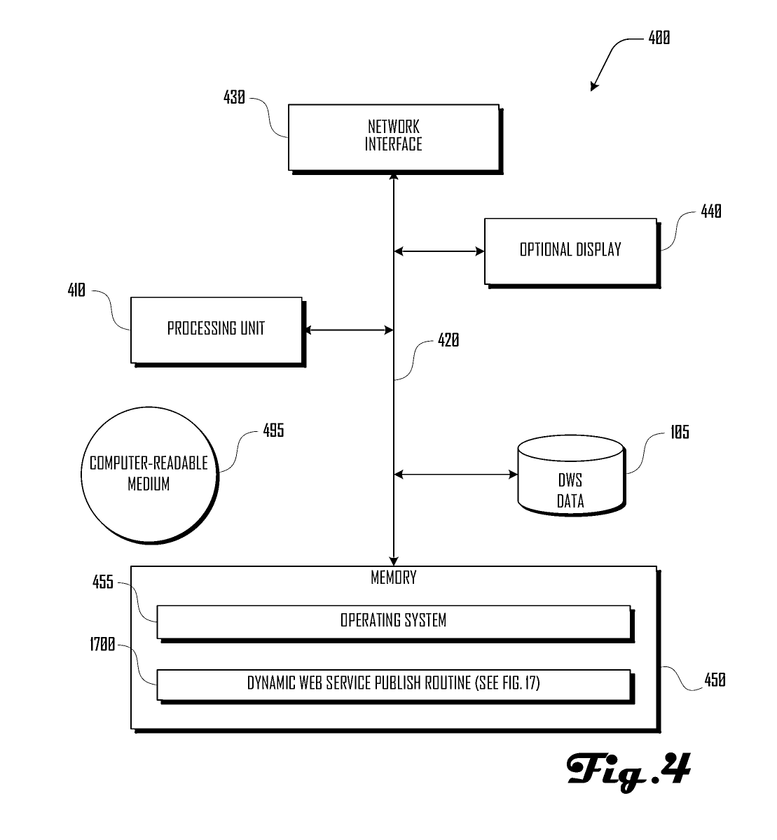

FIG. 2 illustrates several components of an exemplary dynamic-web-service manager server 200. In various embodiments, and as discussed further below, dynamic-web-service manager server 200 may publish dynamic web services and manage one or more worker devices (e.g. dynamic-web-service worker device 400 (see FIG. 4, discussed below)). In some embodiments, dynamic-web-service manager server 200 may exist on a private network with ERP server 110 and client device 300. In other embodiments, dynamic-web-service manager server 200 may communicate with client device 300 via a virtual private network or a public network such as the Internet.

In some embodiments, dynamic-web-service manager server 200 may include many more components than those shown in FIG. 2. However, it is not necessary that all of these generally conventional components be shown in order to disclose an illustrative embodiment. As shown in FIG. 2, the dynamic-web-service manager server 200 includes a network interface 230 for connecting to the network 150.

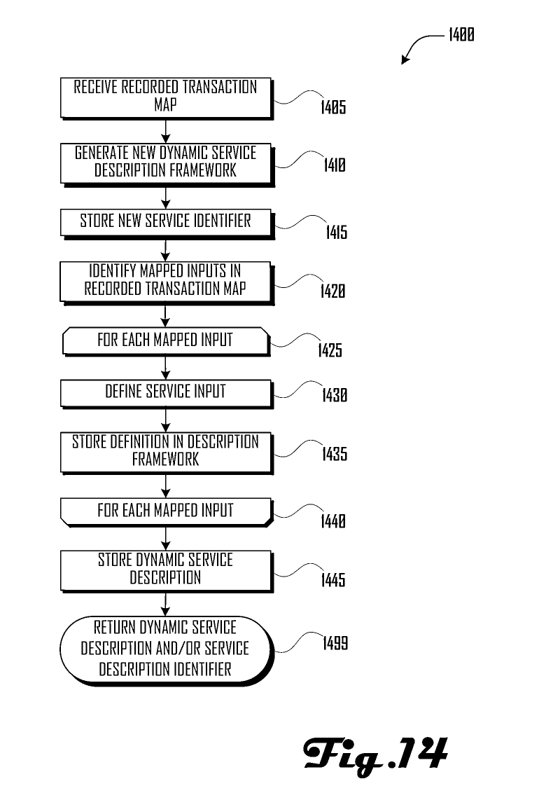

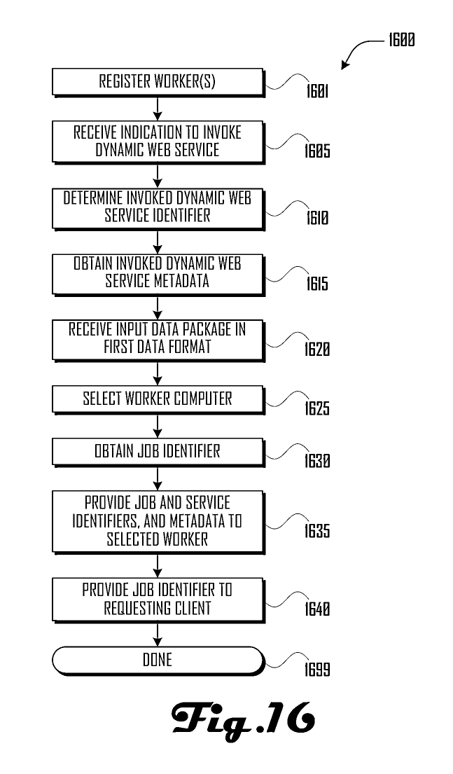

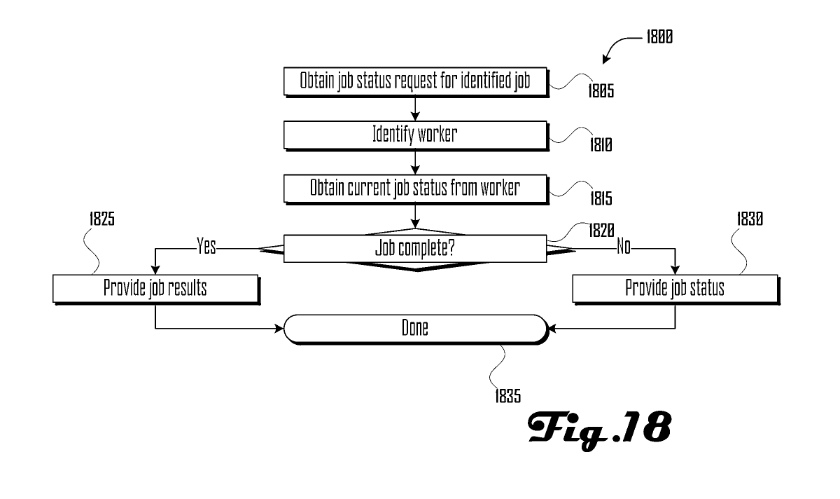

The dynamic-web-service manager server 200 also includes a processing unit 210, a memory 250, and an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for a routine 1400 for publishing a dynamic web service (see FIG. 14, discussed below); a routine 1600 for providing a dynamic web service (see FIG. 16, discussed below); and a routine 1800 for monitoring a dynamic-web-service job status (see FIG. 18, discussed below).

In addition, the memory 250 also stores an operating system 255. These software components may be loaded from a computer readable storage medium 295 into memory 250 of the dynamic-web-service manager server 200 using a drive mechanism (not shown) associated with a computer readable storage medium 295, such as a floppy disc, tape, DVD/CD-ROM drive, memory card, or the like. In some embodiments, software components may also be loaded via the network interface 230, rather than via a computer readable storage medium 295.

Dynamic-web-service manager server 200 also communicates via bus 220 with dynamic-web-service data store 105. In various embodiments, bus 220 may comprise a storage area network (“SAN”), a high speed serial bus, and/or via other suitable communication technology. In some embodiments, dynamic-web-service manager server 200 may communicate with dynamic-web-service data store 105 via network interface 230.

Although an exemplary dynamic-web-service manager server 200 has been described that generally conforms to conventional general purpose computing devices, an dynamic-web-service manager server 200 may be any of a great number of devices capable of communicating with the network 150 and/or ERP server 110, for example, a personal computer, a game console, a set-top box, a handheld computer, a cell phone, or any other device that is capable of providing web services and communicating via a native-API with ERP server 110.

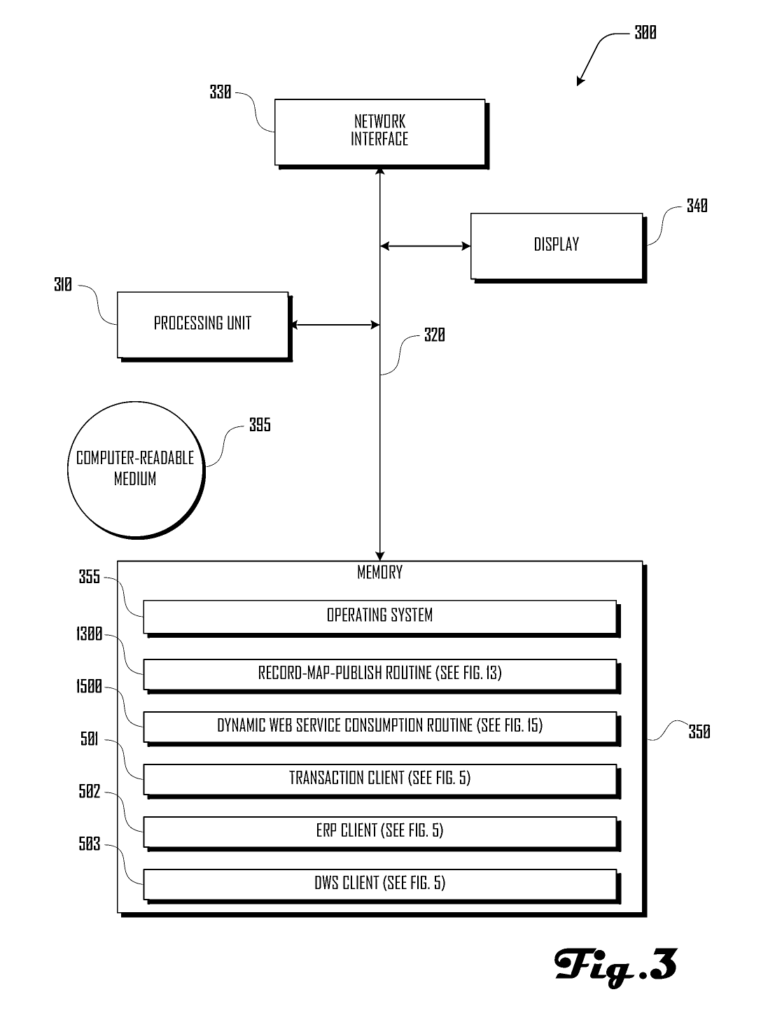

FIG. 3 illustrates several components of an exemplary client device 300. In some embodiments, client device 300 may include many more components than those shown in FIG. 3. However, it is not necessary that all of these generally conventional components be shown in order to disclose an illustrative embodiment. As shown in FIG. 3, the client device 300 includes a network interface 330 for connecting to the network 150.

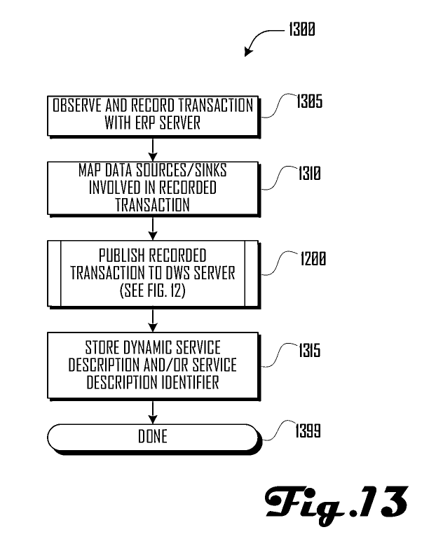

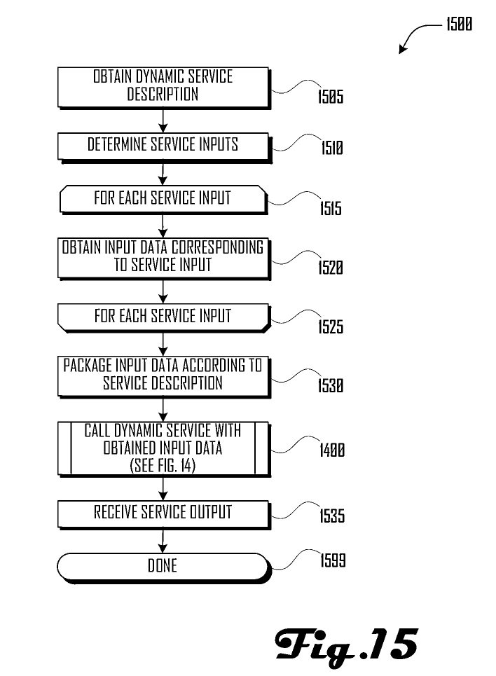

The client device 300 also includes a processing unit 310, a memory 350, and a display 340, all interconnected along with the network interface 330 via a bus 320. The memory 350 generally comprises a random access memory (“RAM”), a read only memory (“ROM”), and a permanent mass storage device, such as a disk drive. The memory 350 stores program code for a routine 1300 for recording, mapping, and publishing a dynamic web service (see FIG. 13, discussed below) and a routine 1500 for consuming a dynamic web service (see FIG. 15, discussed below).

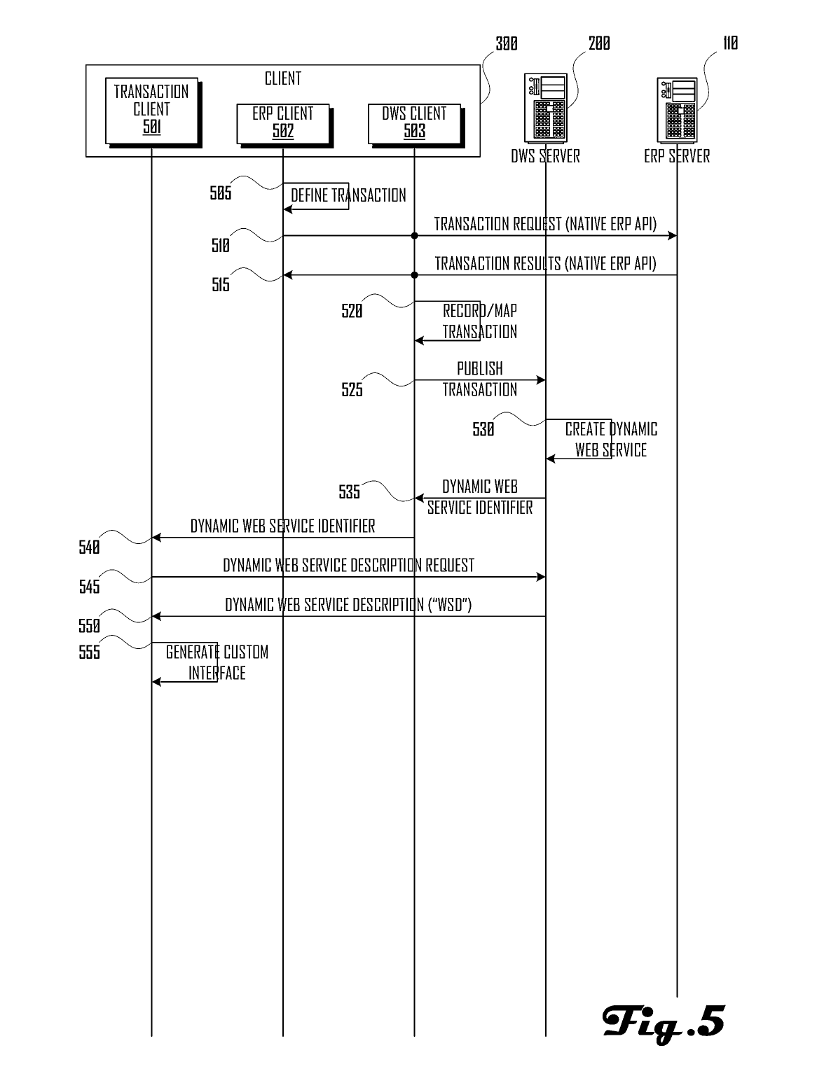

In addition, the memory 350 also stores an operating system 355, as well as an ERP client 502, a dynamic web service client 503, and a custom transaction client 501 (see FIG. 5, discussed below). These software components may be loaded from a computer readable storage medium 395 into memory 350 of the client device 300 using a drive mechanism (not shown) associated with a computer readable storage medium 395, such as a floppy disc, tape, DVD/CD-ROM drive, memory card, or the like. In some embodiments, software components may also be loaded via the network interface 330, rather than via a computer readable storage medium 395.

Although an exemplary client device 300 has been described that generally conforms to conventional general purpose computing devices, an client device 300 may be any of a great number of devices capable of communicating with the network 150 and/or ERP server 110, for example, a personal computer, a game console, a set-top box, a handheld computer, a cell phone, or any other device that is capable of accessing a accessing web services.

FIG. 4 illustrates several components of an exemplary dynamic-web-service worker device 400. In various embodiments, and as discussed further below, several worker devices may register with dynamic-web-service manager server 200 as agents having capabilities to perform transactions involving ERP server 110. In some embodiments, dynamic-web-service worker device 400 may exist on a private network with ERP server 110. In other embodiments, dynamic-web-service manager server 200 may communicate with ERP server 110 via a virtual private network.

In some embodiments, dynamic-web-service worker device 400 may include many more components than those shown in FIG. 4. However, it is not necessary that all of these generally conventional components be shown in order to disclose an illustrative embodiment. As shown in FIG. 4, the dynamic-web-service worker device 400 includes a network interface 430 for connecting to the network 150.

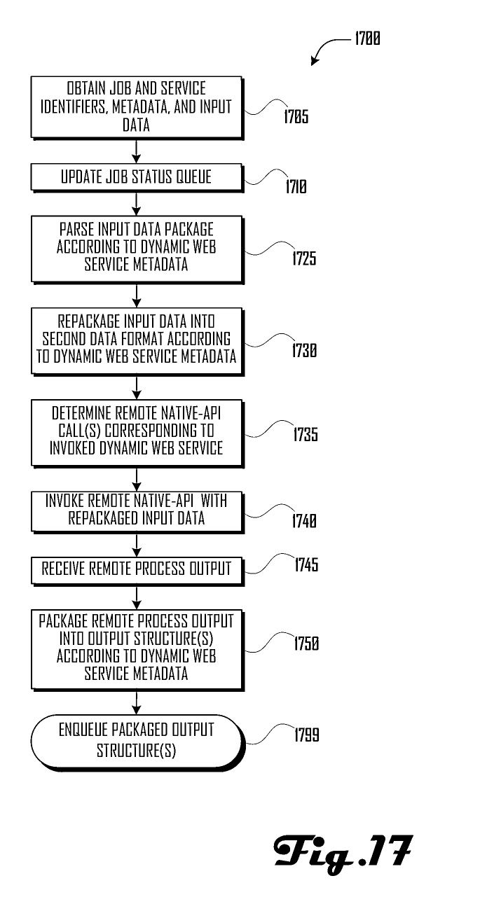

The dynamic-web-service worker device 400 also includes a processing unit 410, a memory 450, and an optional display 440, all interconnected along with the network interface 430 via a bus 420. The memory 450 generally comprises a random access memory (“RAM”), a read only memory (“ROM”), and a permanent mass storage device, such as a disk drive. The memory 450 stores program code for a routine 1700 for performing a dynamic web service job (see FIG. 17, discussed below).

In addition, the memory 450 also stores an operating system 455. These software components may be loaded from a computer readable storage medium 495 into memory 450 of the dynamic-web-service manager server 200 using a drive mechanism (not shown) associated with a computer readable storage medium 495, such as a floppy disc, tape, DVD/CD-ROM drive, memory card, or the like. In some embodiments, software components may also be loaded via the network interface 430, rather than via a computer readable storage medium 495.

Dynamic-web-service worker device 400 also communicates via bus 420 with dynamic-web-service data store 105. In various embodiments, bus 420 may comprise a storage area network (“SAN”), a high speed serial bus, and/or via other suitable communication technology. In some embodiments, dynamic-web-service manager server 200 may communicate with dynamic-web-service data store 105 via network interface 430.

Although an exemplary dynamic-web-service manager server 200 has been described that generally conforms to conventional general purpose computing devices, a dynamic-web-service worker device 400 may be any of a great number of devices capable of communicating with the network 150 and/or ERP server 110, for example, a personal computer, a game console, a set-top box, a handheld computer, a cell phone, or any other device that is capable of providing web services and communicating via a native-API with ERP server 110.

FIG. 5 illustrates an exemplary series of communications between client device 300, dynamic-web-service manager server 200, and ERP server 110, in accordance with one embodiment. In one embodiment, three software processes on client device 300 are involved: an ERP client 502, a dynamic web service client 503, and a custom transaction client 501. Beginning the illustrated sequence of operations, a user defines a transaction 505 using ERP client 502.

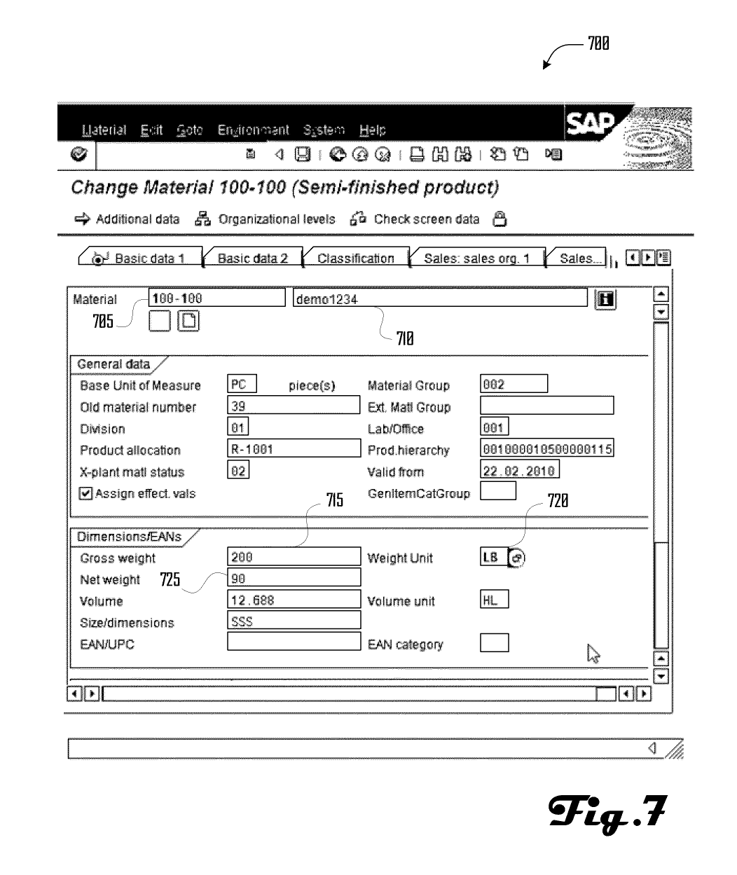

For example, as illustrated in FIG. 7, a user may in one embodiment define and perform a transaction using an SAP client, such as SAPgui 700. In the exemplary transaction illustrated in FIG. 7, the user is updating SAP data using a Material Number field 705, a Material Description field 710, a Gross Weight field 715, a Weight Unit field 720, and a Net Weight field 725. Although the exemplary transaction illustrated herein uses SAP's ERP system, in other embodiments, equivalent procedures may be used to implement equivalent functionality in other ERP systems.

Referring again to FIG. 5, once the transaction is defined, ERP client 502 performs the transaction, sending one or more transaction requests 510 to ERP server 110 using a native API provided by the ERP server 110. In response, ERP server 110 returns 515 one or more transaction results (e.g., a list of updated fields, status message(s), log data, responsive data, and the like). For example, in one embodiment, ERP client 502 (e.g., SAPgui) communicates with ERP server 110 (e.g., an SAP server) via one or more RFCs. In other embodiments, ERP server 110 may expose a native API as a web service, in which case, ERP client 502 may communicate with ERP server 110 via SOAP messages, XML messages/data, JSON data, or the like.

As the user defines 505 and performs 510 the transaction, dynamic web service client 503 monitors the user's activities in ERP client 502 and/or monitors the ERP client's communications with ERP server 110. Using data thereby collected, dynamic web service client 503 records and maps 520 the transaction that was defined 505 and performed 510 in ERP client 502.

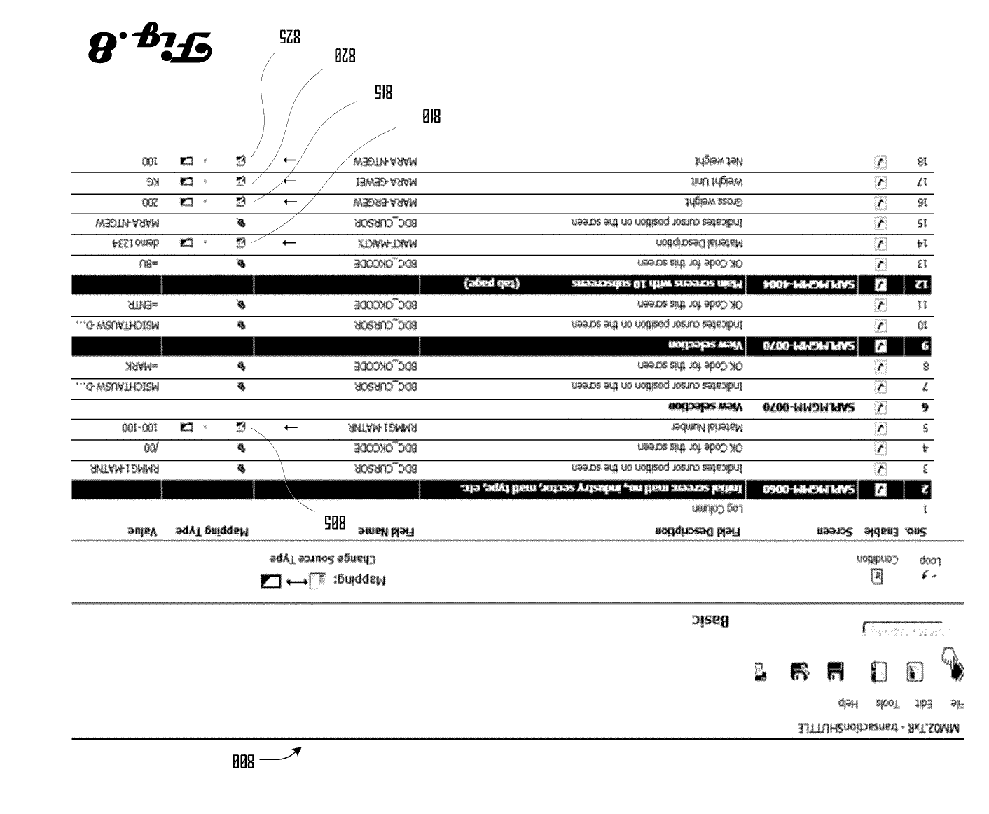

For example, as illustrated in FIG. 8, in one embodiment, a dynamic web service client such as transactionSHUTTLE 800, provided by Winshuttle, Inc. of Bothell, Wash. (the assignee of this application), may record and map the transaction. As illustrated in FIG. 8, transactionSHUTTLE 800 has recorded the exemplary transaction (as defined according to FIG. 7), and the user has mapped the Material Number field 805, the Material Description field 810, the Gross Weight field 815, the Weight Unit field 820, and the Net Weight field 825 to XML sources, indicating that when the recorded transaction is re-played at a later time, values for these fields will be provided by XML data. In other embodiments, one or more of the fields may be mapped to an alternate data source, such as a spreadsheet column or database field.

Referring again to FIG. 5, once the transaction is recorded and mapped 520, dynamic web service client 503 sends a publish transaction request 525 to dynamic-web-service manager server 200. In response, dynamic-web-service manager server 200 creates a dynamic web service 530 for the recorded transaction, including automatically generating a description of the dynamic web service, and returns an identifier 535 for the created dynamic web service.

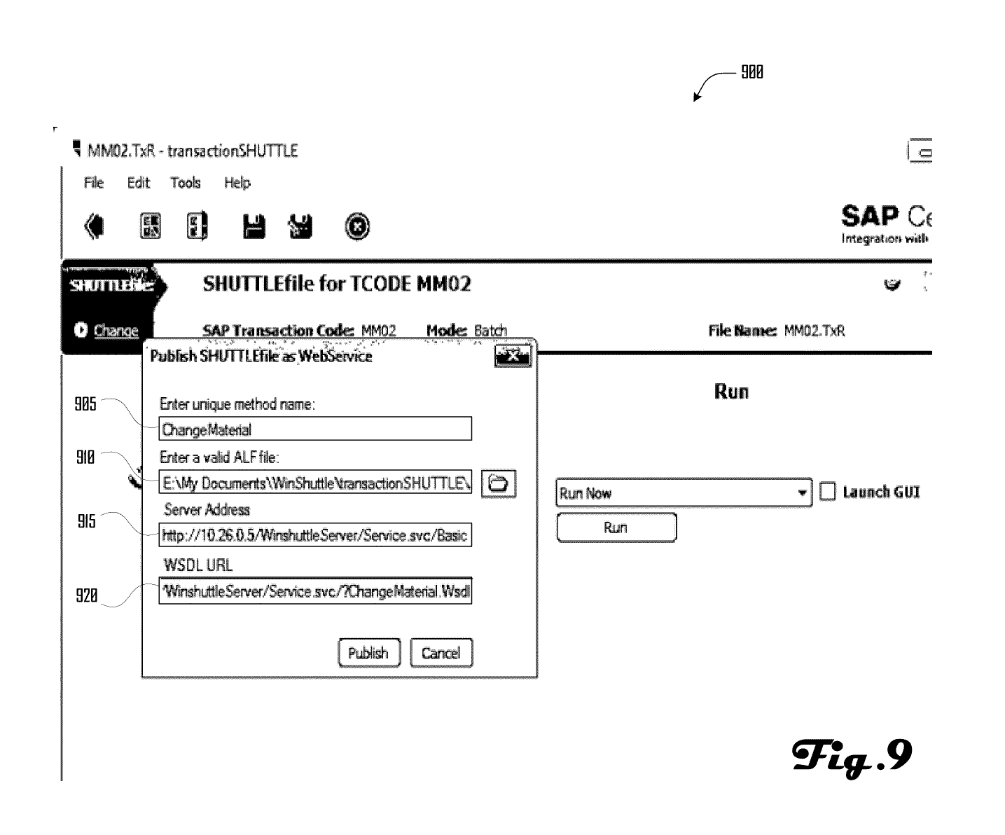

For example, as illustrated in FIG. 9, transactionSHUTTLE 900 has requested that the exemplary transaction (as defined according to FIG. 7) be published as a dynamic web service.

The publication request includes a unique method name 905 for the dynamic web service, an SAP authentication file 910, and a publish-request URL 915 at the dynamic-web-service manager server 200. Also illustrated is the dynamic web service identifier 920 (here, an URL for a WSDL XML schema corresponding to the newly-created dynamic web service) that was returned by dynamic-web-service manager server 200.

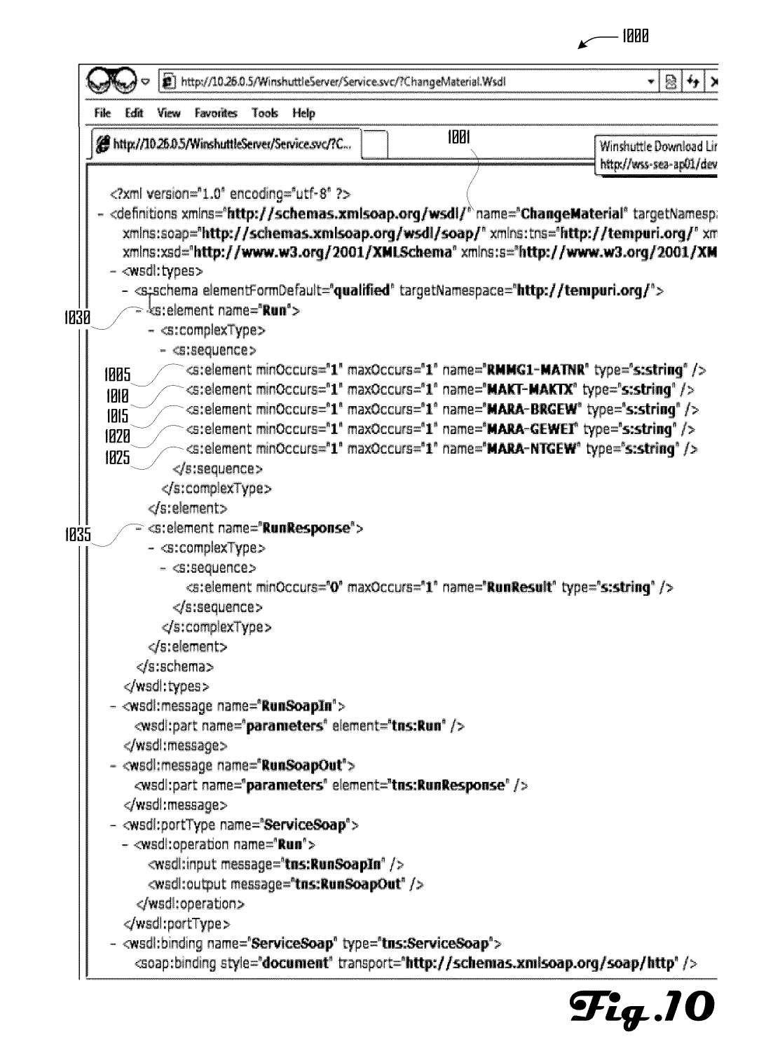

FIG. 10 illustrates a portion of an automatically-generated description (here, a portion of a WSDL XML schema) of a dynamic web service corresponding to an exemplary transaction (as defined according to FIG. 7), in accordance with one embodiment.

The exemplary WSDL XML schema includes a unique method name 1001 for the dynamic web service, as well as element 1030 and element 1035 for running the recorded transaction and for receiving a response from the dynamic-web-service manager server 200. The illustrated element 1030 for running the recorded transaction also includes a series of elements for providing input data to the recorded transaction, including a Material Number element 1005, a Material Description element 1010, a Gross Weight element 1015, a Weight Unit element 1020, and a Net Weight element 1025.

Referring again to FIG. 5, once the transaction has been published as a dynamic web service, dynamic web service client 503 provides the dynamic web service identifier 540 to a custom transaction client 501, which uses the identifier to request a description of the identified dynamic web service 545 from dynamic-web-service manager server 200. Dynamic-web-service manager server 200 returns the requested description 550. Using the received dynamic web service description, transaction client 501 generates a custom interface 555 for providing input data for the recorded transaction.

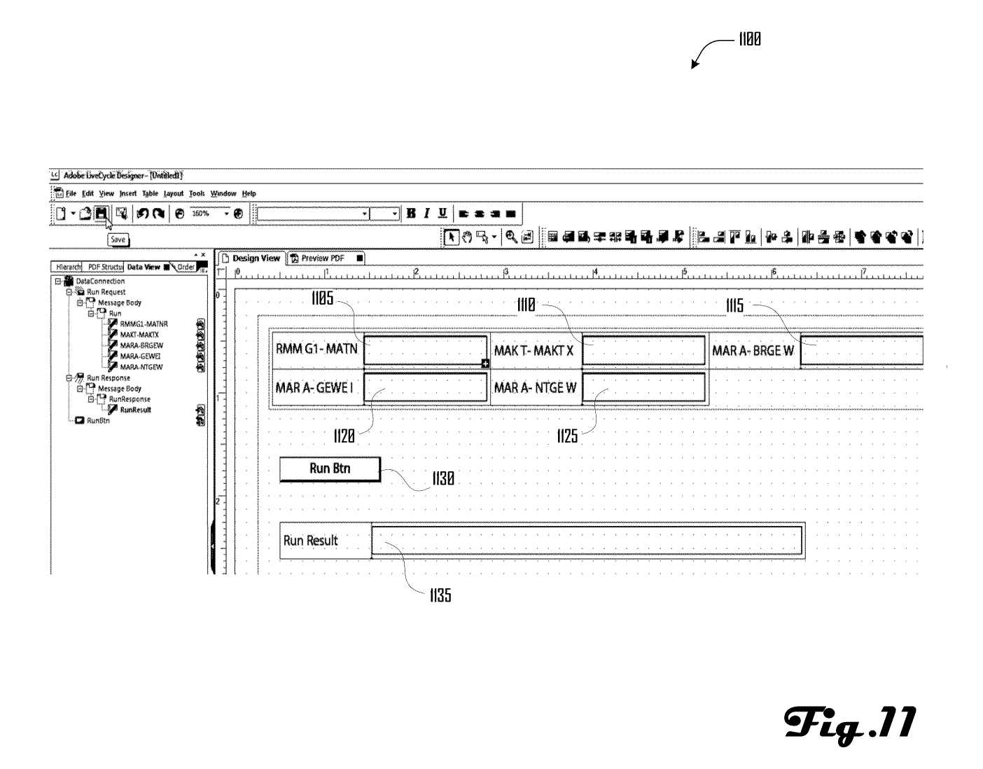

For example, as illustrated in FIG. 11, a forms-authoring tool such as LiveCycle Designer, provided by Adobe Systems Incorporated of Mountain View, Calif., can parse the WSDL XML schema describing the exemplary recorded transaction (as defined according to FIG. 7) and automatically generate a form having fields linked to the appropriate inputs used by the dynamic web service. For example, the form illustrated in FIG. 11 has automatically-generated fields for the Material Number field 115, the Material Description field 1110, the Gross Weight field 1115, the Weight Unit field 1120, and the Net Weight field 1125. The form illustrated in FIG. 11 also has an automatically-generated control 1130 for performing the transaction and an automatically-generated field 1135 for displaying output from performing the transaction (if any). In many embodiments, a user may further customize the automatically-generated form, such as by providing user-friendly names, rearranging and/or resizing form fields, and the like.

In other embodiments, other forms-authoring tools may be employed to at least partially automatically generate a form having fields linked to the appropriate inputs used by the dynamic web service. For example, in various embodiments, a form may be generated using a tool such as Microsoft InfoPath forms, provided by Microsoft Corporation of Redmond, Wash.; a Windows Forms application, such as Microsoft Visual Studio, also provided by Microsoft Corporation of Redmond, Wash.; a mobile forms builder, such as Canvas, provided by Canvas Solutions, Inc. of Herndon, Va.; and/or a web-form builder, such as Oracle Application Express (APEX), provided by Oracle Corporation of Redwood Shores, Calif.

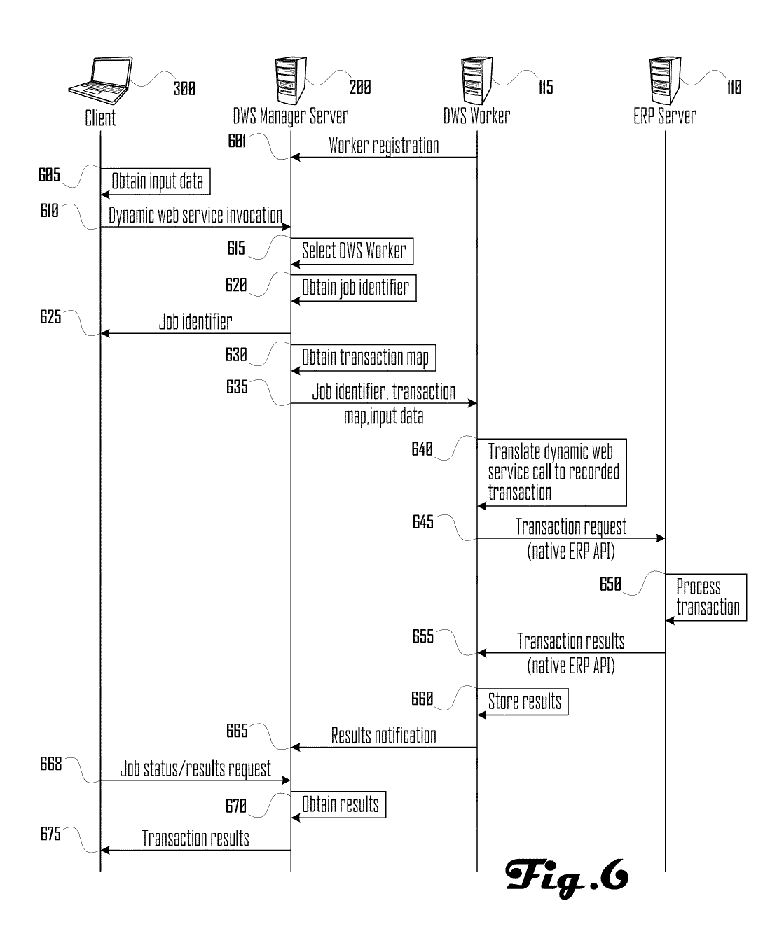

FIG. 6 illustrates an exemplary series of communications between client device 300, dynamic-web-service manager server 200, dynamic-web-service worker device 400, and ERP server 110, in accordance with one embodiment.

Beginning the illustrated series of communications, dynamic-web-service worker device 400 sends to dynamic-web-service manager server 200 registration data 601, including one or more capabilities descriptors indicating types of transactions with ERP server 110 that dynamic-web-service worker device 400 can handle. For example, in one embodiment, dynamic-web-service worker device 400 may indicate that it can perform transactions that may or may not include GUI scripting. Generally, multiple additional dynamic-web-service worker devices 400 (not shown) may send similar registration data to dynamic-web-service manager server 200, which data dynamic-web-service manager server 200 uses to select an appropriate worker device when a client invokes a dynamic web service.

Once the custom transaction client 501 has generated a custom interface for providing input data for the recorded transaction (as discussed above in reference to FIG. 5), client device 300 obtains input data from a user 605.

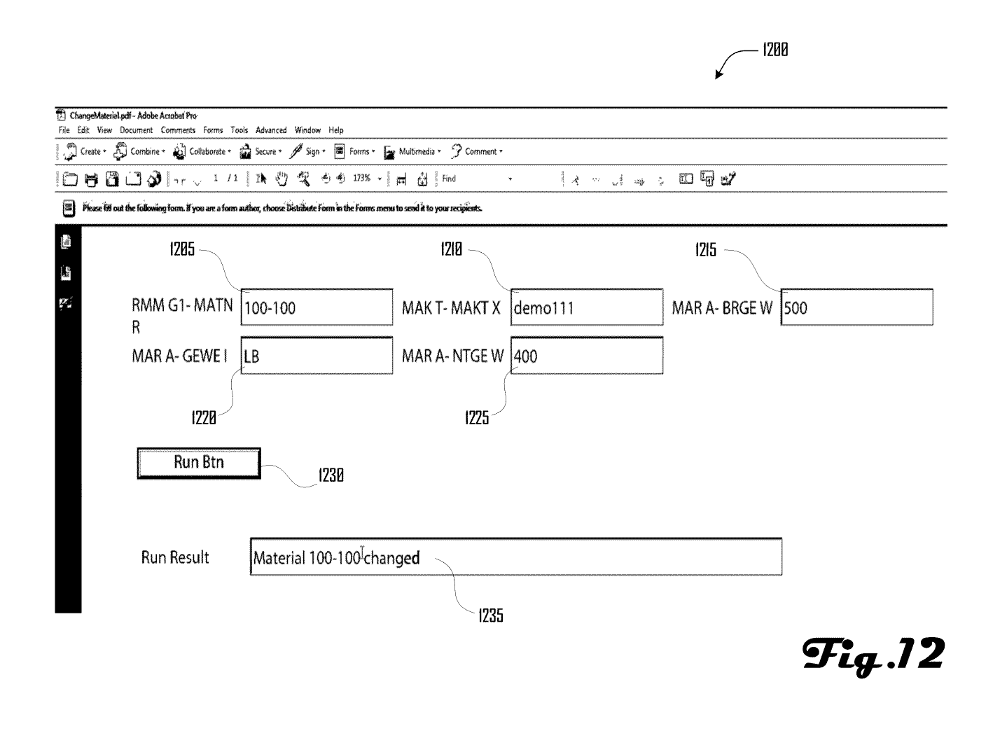

For example, as illustrated in FIG. 12, a form presentation tool such as Acrobat Reader or Acrobat Pro, provided by Adobe Systems Incorporated of Mountain View, Calif., can obtain data from a user for fields in a form 1200 automatically-generated as described herein.

As illustrated in FIG. 12, a user has filled in the form 1200, entering values for the Material Number field 1205, the Material Description field 1210, the Gross Weight field 1215, the Weight Unit field 1220, and the Net Weight field 1225. The user has invoked control 1230 for performing the transaction, and the form invoked the corresponding dynamic web service, sending appropriately-formatted XML data to dynamic-web-service manager server 200, which transformed the dynamic web service request into one or more native-API transactions with ERP server 110. Transaction results are displayed in field 1235.

Although the exemplary transaction client 501 is illustrated as a Portable Document Format (“PDF”) form, in other embodiments, any client that supports web services can be used, including Microsoft InfoPath forms, provided by Microsoft Corporation of Redmond, Wash.; a Windows Forms application, such as Microsoft Visual Studio, also provided by Microsoft Corporation of Redmond, Wash.; and/or a HyperText Markup Language, Adobe Flash, or other web-based front-end that can be called from a web-enabled computer or mobile device. In some embodiments, a transaction client 501 may be deployed on a mobile device, such as a mobile phone, PDA, tablet, game console, or the like, which may or may not be the same device on which the transaction was originally recorded.

Referring again to FIG. 6, client device 300 sends a dynamic web service invocation 610 to dynamic-web-service manager server 200, the invocation including the collected input data.

Using registration data 601, dynamic-web-service manager server 200 selects 615 dynamic-web-service worker device 400 as being capable of handling the invoked dynamic web service and obtains 620 an identifier (e.g., by generating or otherwise obtaining a universally unique identifier or other globally unique identifier) to identify the requested job.

Dynamic-web-service manager server 200 identifies and obtains the recorded transaction 630 corresponding to the dynamic web service invocation, and sends to the selected worker device the job identifier, the transaction map and input data 635. In some embodiments, sending the job identifier, the transaction map and input data to dynamic-web-service worker device 400 may include enqueuing such data in a shared queue for passing job input and output between dynamic-web-service manager server 200 and dynamic-web-service worker device 400.

Upon dequeuing or otherwise obtaining the job identifier, the transaction map and input data, dynamic-web-service worker device 400 transforms 640 the dynamic web service invocation into one or more transaction requests, and sends the one or more transaction requests 645 to ERP server 110 via a native ERP API. ERP server 110 processes 650 the requested transaction, and returns to dynamic-web-service worker device 400 transaction results 655 (if any) via the native ERP API.

Dynamic-web-service worker device 400 stores 660 the results (e.g. by storing the results in a database shared with dynamic-web-service manager server 200 and/or by enqueuing the results into an output queue shared with and/or monitored by dynamic-web-service manager server 200), upon which dynamic-web-service manager server 200 receives a notification 665 that results for the job are available.

At some point thereafter, client device 300 sends to dynamic-web-service manager server 200 a request 668 requesting a job status and/or job results. In response, dynamic-web-service manager server 200 obtains 670 the results (e.g., from a shared database or output queue) and sends the transaction results 675 (if any) to client device 300.

FIG. 13 illustrates a routine 1300 for recording, mapping, and publishing a dynamic web service, such as may be performed by a client device 300 in accordance with one embodiment.

In block 1305, routine 1300 observes and records a native-ERP-API transaction between an ERP client 502 and ERP server 110. For example, in one embodiment, a dynamic web service client 503 (e.g., transactionSHUTTLE) may observe and record a transaction between an ERP client 502 (e.g., SAPGui) and ERP server 110 (e.g., SAP server), for example, via an SAP GUI scripting interface. In some embodiments, routine 1300 may also monitor network communications between an ERP client 502 and ERP server 110.

In block 1310, routine 1300 maps data sources and/or data sinks (if any) involved in the recorded transaction. For example, in some embodiments, ERP server 110 may return a list of fields involved in the transaction or other metadata about the transaction. In some embodiments, routine 1300 may observe the user interacting with particular fields in the ERP client 502. In some embodiments, routine 1300 may solicit mapping information from a user, accepting user input to create mappings between particular input and/or output fields involved in the transaction and external data sources and/or data sinks (e.g., XML data, spreadsheet data, database data, and the like). In some embodiments, one or more of the fields involved in the transaction may not be mapped to an external source, but the data provided during the original transaction recording is treated as static data for that field.

In subroutine block 1400, routine 1300 calls remote publish routine 1400 (see FIG. 14, discussed below) at dynamic-web-service manager server 200 to have the recorded and mapped transaction published as a dynamic web service. For example, in one embodiment, dynamic-web-service manager server 200 may provide a static “Publish” web service that routine 1300 can use to have the recorded/mapped transaction published as a dynamic web service.

In some embodiments, routine 1400 returns a dynamic service description and/or a dynamic service description identifier (e.g., a WSDL XML schema describing the dynamic web service and/or an URL for such a WSDL file), and in block 1315, routine 1300 stores (at least transiently) the dynamic service description and/or a dynamic service description identifier. Routine 1300 ends in block 1399.

FIG. 14 illustrates a routine 1400 for publishing a dynamic web service, such as may be performed by a dynamic-web-service manager server 200 in accordance with one embodiment.

In block 1405, routine 1400 receives a recorded transaction map describing a recorded transaction between an ERP client 502 and ERP server 110 and mapping one or more fields involved in the transaction to one or more external data sources (e.g., to XML data). For example, in one embodiment, routine 1400 receives a “TxR” file, such as those created by the transactionSHUTTLE software application.

Using the recorded transaction map, in block 1410, routine 1400 automatically generates a description framework for a new dynamic web service corresponding to the recorded transaction. For example, in one embodiment, routine 1400 generates a framework for a WSDL XML schema such as that partially illustrated in FIG. 10, discussed above. In some embodiments, routine 1400 may store the description framework in dynamic-web-service data store 105.

In block 1415, routine 1400 determines (if need be) and stores a new service identifier for the dynamic web service that will correspond to the recorded transaction map. In some embodiments, routine 1400 may store the service identifier in dynamic-web-service data store 105. For example, for the exemplary transaction illustrated in FIGS. 5-8, discussed above, routine 1400 may store the unique dynamic web service identifier, “ChangeMaterial” (see method name field 905, above).

In block 1420, routine 1400 identifies one or more input fields that have been mapped to one or more external data sources. Beginning in block 1425, routine 1400 processes each identified mapped input field. In block 1430, routine 1400 defines an input for the dynamic web service corresponding to the current mapped input field. In block 1435, routine 1400 stores the defined input in the service description framework. In block 1440, routine 1400 cycles back to block 1425 to process the next mapped input field (if any).

For example, for the exemplary transaction illustrated in FIGS. 5-8, discussed above, routine 1400 may identify an input field mapped to a “Material Number” data source (e.g., Material Number field 805 in FIG. 8) and generate and store a corresponding input element in a WSDL XML schema (e.g., element 1005 in FIG. 10). Similarly, for the exemplary transaction, routine 1400 may further identify mapped input fields 810-25 (as illustrated in FIG. 8) and generate service inputs 1010-25 (as illustrated in FIG. 10).

Having generated and stored an identifier and description for a new dynamic web service corresponding to a recorded transaction map, in block 1445, routine 1400 stores completed dynamic web service description, for example, in dynamic-web-service data store 105. In some embodiments, routine 1400 may also obtain and store additional data and/or files, such as ERP authentication credentials, such as SAP authentication file field 910 (see FIG. 9).

Routine 1400 ends in block 1499, making available at least one of the identifier and the description, e.g., to the calling routine (which may be a remote process on a client device, e.g., client device 300). For example, in one embodiment, routine 1400 may return an URL containing the unique dynamic web service identifier. In one embodiment, this URL simply returns the dynamic web service description stored in block 1445 (e.g., a WSDL XML Schema) to a requestor. For example, if the unique dynamic web service identifier is “CreateMaterial,” then in one embodiment, the returned URL may take the following form: “http://abc.com/winshuttleserver/Service.svc/CreateMaterial?WSDL”. Since the dynamic web service identifier is unique, this URL is also unique and specific to the published service.

FIG. 15 illustrates a routine 1500 for consuming a dynamic web service, such as may be performed by a client device 300 in accordance with one embodiment.

More specifically, in some embodiments, routine 1500 may be performed by a transaction client 501 on client device 300 in communication with dynamic-web-service manager server 200.

In block 1505, routine 1500 obtains a description for a dynamic web service corresponding to a recorded transaction with ERP server 110. For example, in some embodiments, routine 1500 may obtain an URL (e.g., from dynamic web service client 503) from which routine 1500 requests and receives a service description. In other embodiments, routine 1500 may obtain such an URL and/or service description from a local process (e.g., dynamic web service client 503) or file.

In block 1510, routine 1500 determines one or more service inputs mapped to one or more external data sources in the dynamic service description. Beginning in block 1515, routine 1500 processes each identified service input. In block 1520, routine 1500 obtains input data corresponding to the current service input. In block 1525, routine 1500 cycles back to block 1515 to process the next service input (if any).

For example, for the exemplary transaction illustrated in FIGS. 8-10, discussed above, routine 1500 may identify a service input mapped to a “Material Number” data source (e.g., element 1005 in FIG. 10) obtain corresponding input from a user (e.g., via form field 1205 in FIG. 12). Similarly, for the exemplary transaction, routine 1500 may further identify service inputs service input 1010-25 (as illustrated in FIG. 10) and obtain inputs via corresponding form field 1210-25 (as illustrated in FIG. 12).

In block 1530, routine 1500 packages the obtained input data according to the obtained dynamic service description. For example, in one embodiment, routine 1500 packages the input data into XML according to the WSDL service description. In some embodiments, routine 1500 packages the input data into an XML SOAP message according to the WSDL service description.

In subroutine block 1600, routine 1500 calls routine 1600 (see FIG. 16, discussed below), passing the packaged data to the dynamic web service corresponding to the obtained dynamic web service description. In some embodiments, routine 1600 is a remote process that routine 1500 invokes on dynamic-web-service manager server 200 by calling a static “Run” web service, passing in as parameters a dynamic web service identifier and the corresponding packaged data.

In block 1535, routine 1500 receives output from the invoked dynamic web service (if any). For example, in some embodiments, the dynamic web service may return log information, and/or requested data structures. Routine 1500 ends in block 1599.

FIG. 16 illustrates a routine 1600 for providing a dynamic web service, such as may be performed by a dynamic-web-service manager server 200 in accordance with one embodiment.

In block 1601, routine 1600 obtains registration data from one or more worker devices, the registration data indicating that each of the worker devices is an agent having capabilities to perform one or more types of transactions involving ERP server 110.

In block 1605, routine 1600 receives an indication (e.g. from client device 300) to invoke a dynamic web service. For example, in one embodiment, a static web service (e.g., a “Run” web service) may be invoked with an indication of a dynamic web service to perform.

In block 1610, routine 1600 determines an identifier corresponding to the indicated dynamic web service. For example, in one embodiment, routine 1600 may determine a dynamic web service identifier passed in as a parameter to a static web service.

In block 1615, routine 1600 obtains metadata corresponding to the identified dynamic web service. For example, in one embodiment, routine 1600 obtains metadata from a metadata library in dynamic-web-service data store 105. In some embodiments, the obtained metadata includes information from a recorded transaction map. In some embodiments, the obtained metadata may also include ERP authentication credentials.

In block 1620, routine 1600 obtains a package of input data in a first data format. For example, in one embodiment, routine 1600 obtains XML and/or SOAP data corresponding to one or more input fields.

In block 1625, routine 1600 determines a transaction type of the invoked dynamic web service (e.g. a transaction that does or does not include GUI scripting) and selects a worker device that is capable of handling jobs of such a type. In some embodiments, routine 1600 may also consider factors such as whether the selected device is currently busy compared to other worker devices and/or the length of an input queue associated with the selected worker device compared to those of other worker devices.

In block 1630, routine 1600 obtains a job identifier (e.g., by generating or otherwise obtaining a universally unique identifier or other globally unique identifier) to identify the requested job.

In block 1635, routine 1600 provides to the selected worker device the job identifier, an identifier identifying the requested dynamic web service, and metadata associated therewith (including the package of input data).

In block 1640, routine 1600 provides the job identifier obtained in block 1630 to the client that requested invocation of the dynamic web service.

Routine 1600 ends in ending block 1699.

FIG. 17 illustrates a routine 1700 for performing a dynamic web service job, such as may be performed by a dynamic-web-service worker device 400 in accordance with one embodiment.

In block 1705, routine 1700 obtains a job identifier, a service identifier, and metadata associated therewith (including a recorded transaction map), e.g. from dynamic-web-service manager server 200.

In block 1710, routine 1700 updates a shared queue for passing job input, status, and/or output between routine 1700 and a calling device (e.g. dynamic-web-service manager server 200). For example, in one embodiment, routine 1700 may update a shared queue to indicate that the identified job has been enqueued or is in progress. In some embodiments, the calling device may automatically receive a notification when statuses, results, or other messages are enqueued in the shared queue.

In block 1725, routine 1700 parses the input data package according to the obtained dynamic web service metadata, and if necessary, in block 1730, routine 1700 repackages the input data into a second data format according to the dynamic web service metadata. For example, in one embodiment, routine 1700 repackages XML and/or SOAP data structures into one or more packages of data structured so as to comply with an RFC calling mechanism used to communicate via a native-API with ERP server 110.

In block 1735, using the obtained dynamic web service metadata, routine 1700 determines one or more remote native-ERP-API calls corresponding to the invoked dynamic web service. For example, in one embodiment, routine 1700 may determine one or more RFC calls that were recorded between an ERP client 502 and ERP server 110.

In block 1740, routine 1700 invokes the one or more remote native-ERP-API calls on ERP server 110, using the repackaged input data in place of the input data originally provided in the recorded transaction. In some embodiments, routine 1700 may essentially “mimic” the behavior of the ERP client 502 from which the transaction was originally recorded, using RFC to invoke the ERP Server's native-ERP-API. In other embodiments, routine 1700 may use a native-ERP web service API to perform the recorded transaction with the newly provided input data.

In block 1745, routine 1700 receives output data from the remotely-invoked native-ERP-API calls (if any). In block 1750, routine 1700 packages the output data into one or more output structures (if any) identified in the dynamic web service metadata.

In ending block 1799, routine 1700 ends, enqueuing the packaged output structures (if any), e.g., in a shared output queue, from which it may be retrievable by the calling device.

FIG. 18 illustrates a routine 1800 for monitoring a dynamic-web-service job status, such as may be performed by a dynamic-web-service manager server 200 in accordance with one embodiment.

In block 1805, routine 1800 obtains a request (e.g. from client device 300) for results and/or a current job status associated with an identified job.

In block 1810, routine 1800 identifies a worker device (e.g., dynamic-web-service worker device 400) to which the job in question has been assigned.

In block 1815, routine 1800 obtains a current job status and/or job results associated with the job in question. For example, in one embodiment, routine 1800 may consult a shared status and/or output queue associated with the identified worker device.

In decision block 1805, routine 1800 determines whether the current job status obtained in block 1815 indicates that the job in question is complete and/or whether results are available.

If so, then in block 1820, routine 1800 provides results associated with the completed job to the requesting device.

Otherwise, if in decision block 1805, routine 1800 determines that the current job status obtained in block 1815 indicates that the job in question is not complete and/or that results are not available, then in block 1825, routine 1800 provides the current job status (e.g., enqueued, in progress, error) to the requesting device.

Routine 1800 ends in ending block 1899.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. For example, although the description above refers to embodiments involving enterprise resource planning systems, other embodiments may be similarly used in other types of enterprise application systems in which a transaction between an enterprise client and an enterprise server may be recorded and mapped, as variously described above. For example, the systems and methods described herein may be used in connection with enterprise systems such as customer relationship management (“CRM”) systems, accounting systems, supply chain management systems, and the like. This application is intended to cover any adaptations or variations of the embodiments discussed herein.

1. A manager-computer-implemented method for publishing a dynamic web service, the method comprising:
registering, by the manager computer, a plurality of worker computers, each worker computer being capable to process recorded transactions of at least one transaction type of a plurality of transaction types;
receiving, by the manager computer from an enterprise-application client, a recorded transaction map describing a recorded transaction between said enterprise-application client and a remote enterprise-application server, said recorded transaction map including field metadata corresponding to a plurality of transaction fields and type metadata corresponding to a first transaction type of said plurality of transaction types;
automatically generating, by the manager computer, a service description framework for a new dynamic web service corresponding to said recorded transaction;
receiving, by the manager computer, an invocation request from said enterprise-application client to invoke said new dynamic web service according to a package of input data;
selecting, by the manager computer based at least in part on said first transaction type, a worker-computer of said plurality of worker computers;
obtaining, by the manager computer, a unique job identifier corresponding to said invocation request;
providing, by the manager computer to said enterprise-application client, said unique job identifier; and
providing said recorded transaction map, said unique job identifier, and said package of input data to said selected worker-computer to invoke said remote enterprise-application server to perform said recorded transaction according to said package of input data.

2. The method of claim 1, further comprising:
receiving, from said enterprise-application client, a status request including said unique job identifier;
identifying said selected worker-computer as being associated with said unique job identifier;
obtaining a current status state associated with said selected worker-computer in reference to said unique job identifier; and
providing said current status state to said enterprise-application client.

3. The method of claim 1, further comprising:
receiving a notification that process-output data corresponding to said unique job identifier is available from said selected worker-computer in a shared data store;
obtaining said process-output data from said shared data store; and
providing said process-output data to said enterprise-application client.

4. The method of claim 1, wherein receiving said recorded transaction map comprises receiving said recorded transaction map from a private local-area network via a public network.

5. The method of claim 4, wherein invoking said remote enterprise-application server to perform said recorded transaction comprises calling said remote enterprise-application server, by said selected worker-computer via a virtual private network extending said private local-area network.

6. The method of claim 4, wherein providing said recorded transaction map, said unique job identifier, and said package of input data to said selected worker-computer comprises sending said recorded transaction map, said unique job identifier, and said package of input data to said selected worker-computer via said public network to said private local-area network.

7. The method of claim 1, further comprising:
receiving said package of input data according to a first calling mechanism; and
repackaging said package of input data into repackaged input data that complies with a second calling mechanism.

8. The method of claim 7, wherein repackaging said package of input data to comply with said second calling mechanism comprises providing, via said first calling mechanism, said package of input data to said selected worker-computer for repackaging prior to invoking said remote enterprise-application server.

9. The method of claim 7, wherein said selected worker-computer invoking said remote enterprise-application server to perform said recorded transaction comprises:
determining, by said selected worker-computer according to recorded transaction map, at least one enterprise application API call for performing said recorded transaction; and
calling said remote enterprise-application server, by said selected worker-computer, according to said second calling mechanism, said at least one enterprise application API call, and said repackaged input data.

10. The method of claim 1, wherein automatically generating said service description framework comprises, for each of said plurality of transaction fields:
defining an input corresponding to the current transaction field; and
storing the defined input in said service description framework.

11. The method of claim 1, wherein said remote enterprise-application server comprises an ERP server.

12. A computing apparatus comprising a processor and a memory having stored therein instructions that when executed by the processor, configure the apparatus to perform a method for publishing a dynamic web service, the method comprising:
registering a plurality of worker computers, each worker computer being capable to process recorded transactions of at least one transaction type of a plurality of transaction types;
receiving, from an enterprise-application client, a recorded transaction map describing a recorded transaction between said enterprise-application client and a remote enterprise-application server, said recorded transaction map including field metadata corresponding to a plurality of transaction fields and type metadata corresponding to a first transaction type of said plurality of transaction types;
automatically generating a service description framework for a new dynamic web service corresponding to said recorded transaction;
receiving an invocation request from said enterprise-application client to invoke said new dynamic web service according to a package of input data;
selecting, based at least in part on said first transaction type, a worker-computer of said plurality of worker computers;
obtaining a unique job identifier corresponding to said invocation request;
providing, to said enterprise-application client, said unique job identifier; and
providing said recorded transaction map, said unique job identifier, and said package of input data to said selected worker-computer to invoke said remote enterprise-application server to perform said recorded transaction according to said package of input data.

13. The apparatus of claim 12, the method further comprising:
receiving, from said enterprise-application client, a status request including said unique job identifier;
identifying said selected worker-computer as being associated with said unique job identifier;
obtaining a current status state associated with said selected worker-computer in reference to said unique job identifier; and
providing said current status state to said enterprise-application client.

14. The apparatus of claim 12, the method further comprising:
receiving a notification that process-output data corresponding to said unique job identifier is available from said selected worker-computer in a shared data store;
obtaining said process-output data from said shared data store; and
providing said process-output data to said enterprise-application client.

15. The apparatus of claim 12, wherein receiving said recorded transaction map comprises receiving said recorded transaction map from a private local-area network via a public network.

16. The apparatus of claim 15, wherein invoking said remote enterprise-application server to perform said recorded transaction comprises calling said remote enterprise-application server, by said selected worker-computer via a virtual private network extending said private local-area network.

17. A non-transient computer-readable storage medium having stored therein instructions that when executed by a processor, configure the processor to perform a method for publishing a dynamic web service, the method comprising:
registering a plurality of worker computers, each worker computer being capable to process recorded transactions of at least one transaction type of a plurality of transaction types;
receiving, from an enterprise-application client, a recorded transaction map describing a recorded transaction between said enterprise-application client and a remote enterprise-application server, said recorded transaction map including field metadata corresponding to a plurality of transaction fields and type metadata corresponding to a first transaction type of said plurality of transaction types;
automatically generating a service description framework for a new dynamic web service corresponding to said recorded transaction;
receiving an invocation request from said enterprise-application client to invoke said new dynamic web service according to a package of input data;
selecting, based at least in part on said first transaction type, a worker-computer of said plurality of worker computers;
obtaining a unique job identifier corresponding to said invocation request;
providing, to said enterprise-application client, said unique job identifier; and
providing said recorded transaction map, said unique job identifier, and said package of input data to said selected worker-computer to invoke said remote enterprise-application server to perform said recorded transaction according to said package of input data.

18. The storage medium of claim 17, the method further comprising:
receiving, from said enterprise-application client, a status request including said unique job identifier;
identifying said selected worker-computer as being associated with said unique job identifier;
obtaining a current status state associated with said selected worker-computer in reference to said unique job identifier; and
providing said current status state to said enterprise-application client.

19. The storage medium of claim 17, the method further comprising:
receiving a notification that process-output data corresponding to said unique job identifier is available from said selected worker-computer in a shared data store;
obtaining said process-output data from said shared data store; and
providing said process-output data to said enterprise-application client.

20. The storage medium of claim 17, wherein receiving said recorded transaction map comprises receiving said recorded transaction map from a private local-area network via a public network.

21. The storage medium of claim 20, wherein invoking said remote enterprise-application server to perform said recorded transaction comprises calling said remote enterprise-application server, by said selected worker-computer via a virtual private network extending said private local-area network.
